(19) United States
(12) Patent Application Publication
(10) Pub. No.: US 2008/0200216 A1
(43) Pub. Date: Aug. 21, 2008

(54) Car-mounted wireless handfree system for cellular phones and method of use with full size handset, keypad, display, and speaker phone

(76) Inventor: Isaac Schwarcz, Brooklyn, NY (US)

Correspondence Address: Esther E. Schwartz, 1898 Ocean Avenue, Brooklyn, NY, 11230, US

(21) Appl. No.: 11/708,980

(22) Filed: Feb. 21, 2007

(51) Int. Cl. H04M 1/00

(52) U.S. Cl. 455/569.2

(57) ABSTRACT

I have invented a Bluetooth-enabled transfer connection device for wirelessly connecting a cellular phone with a car-mounted car-kit comprising a junction box, a power source, a hang up cup to rest the device, a full size corded handset with a full size keypad and full size visual caller identification display, a connection element for connection to an external earpiece, and a wired connection to an external microphone and speaker system for speaker phone use, adapted for in-car use by a passenger or driver. In the preferred embodiment, the hang up cup will receive the handset in a substantially horizontal configuration, and the handset will be held in place with a locking clip. The preferred embodiment will further comprise a designated key on the keypad providing a novel notepad feature allowing alpha-numeric input and storing options even while the telephone is in use and keytones are disabled. The notepad feature can be activated both while the phone is in use and not in use.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISC

Not Applicable

### BACKGROUND OF THE INVENTION

(1) Field of the Invention

This invention relates to cellular phone accessories and adaptations for cellular phone use in a car environment. More particularly, this invention relates to a car-mounted wireless car-kit system that communicates wirelessly, preferably through the Bluetooth protocol, with a user's cellular phone, providing enhanced comfort and ease of use while using a cellular phone in a car environment. Specifically, the car-mounted wireless car-kit system of the instant invention provides a user with a full size corded handset, full size caller identification display, speaker phone capability, and a designated key on the handset keypad activating a feature mode disabling keytones and allowing input and storage of alpha-numeric data even while the cellular phone is in use. The designated key activating the specialized input and storage mode can be used both while the cellular phone is in use and not in use. In the preferred embodiment, Bluetooth® or other similar wireless technology is used.

(2) Description of the Related Art Including Information Disclosed Under 37 CFR 1.97 and 1.98

The current state of the art contains many cellular phone accessories adapted for in-car use to achieve varying purposes. Yet there does not exist a car-mounted wireless car-kit system providing a cell phone user with a full size corded handset, full size caller identification display, speaker phone capability and a designated key on the handset keypad activating a feature mode disabling keytones and allowing input and storage of alpha-numeric data while the cellular phone is in use.

Cellular phone use has exploded exponentially in recent years. Constant availability by cellular phone is expected. Before the common-place use of cellular telephone technology, availability by telephone was limited to land-line telephone connections, and old-style car telephones.

With the availability and convenience of ultra-small and lightweight portable cellular telephones, the use of both land-line telephone connections and the original car phones are not as crucial as they once were.

Yet, with the use of cellular telephones, a new problem presented itself: the use of the hand-held cellular telephone device in a car environment.

There are many new cellular telephone accessories that have been adapted to address this problem. Most of these accessories, however, are intended to provide a hands-free device whereby the driver of the vehicle can communicate via a cellular telephone while using both hands to drive. These devices are each imperfect, and only address the concerns of the driver of the automobile while engaging in conversation, and not any of the other inconveniences associated with in-automobile use of a cellular phone.

The instant invention addresses the other concerns created by cellular phone use in a car environment. As cellular telephones become smaller and more compact, they are more portable, but do not afford the user an increase in ease of use. The buttons are miniscule, and the housing too small to talk on for long periods of time comfortably.

In addition, a cellular phone is difficult to use while driving a car. In fact, in many locations use of a hand-held cellular phone is prohibited while driving. Many devices provide various imperfect forms of hands-free cellular phone technology to address this concern.

The full size buttons, full size handset, and full size caller ID display of traditional telephones afford the user much more ease of use and comfort in carrying on a conversation for an extended period of time than a portable cellular phone.

The speaker on a full size handset can be held comfortably to the ear while the microphone reaches substantially near the mouth of the average user. Therefore, while a user would prefer to carry the small portable cellular phone for outside use, while riding as a passenger in a car, the user would prefer the comfort and ease of a full size phone.

In addition, full size buttons and visual display afford the user maximum ease of use. Therefore, while a user would prefer to carry the small portable cellular phone for outside use, while in a car, the user would prefer the comfort and ease of use of controlling their cellular phone with a device mimicking the features of a full size phone.

Furthermore, the speaker-phone modes of current cellular phones or hands-free cellular phone synchronization devices do not provide the use of an automobile-mounted speaker or speaker-phone use through an automobile's existing speaker system concurrent with a full size caller identification display and full size keypad.

Consequently, there is a need for a full size car phone that can connect wirelessly, through Bluetooth or a comparable wireless technology, to a cellular phone, allowing a user to have the convenience of their cellular phone combined with the ease and comfort of a full size car phone while in a car environment with a further option of using the car phone in a speaker phone mode through the car's speaker system or alternate automobile-mounted speaker, further allowing the user to speak into an exterior microphone, preferably mounted on top of the driver's sun visor, and further allowing the user to connect a traditional 2.5 mm earpiece to the system, allowing ultimate comfort, maximum versatility, and ease of use for a driver or passenger in a car.

A further concern is presented when a cellular phone user, while driving or riding in a car, has need to take down information quickly while the cellular phone is in use. The user, while engaging in conversation or listening to a voice mail message, may wish to write down a telephone number, or a name, or other alpha-numeric data. Without a pen and paper readily available, a user may wish to input the data into their cellular phone. However, if the user is engaged mid-conversation, pressing the keys on the keypad activates the key-tones and can irritate the ears of the individual on the other end of the conversation. Furthermore, if the user presses the keys on the keypad while listening to voice mail messages, the user will unwittingly delete a message or rewind or skip messages by pressing the keys assigned to perform those functions. When a key on the keypad is pressed to choose a menu option, the resulting audible key-tone signals the user's choice. If the key-tones were disabled, pressing the keys on the keypad would not signal any menu choices.

No car-mounted wireless car-kit system in the current art provides a designated key enabling a user to store alpha-numeric data both while the phone is in use and while the phone is not in use without irritating the listener or making choices by activating key-tones.

Consequently, there is a further need for a full size car phone that allows a user to store alpha-numeric data while the phone is in use without irritating the listener or making choices by activating key-tones.

U.S. Pat. No. 5,836,563 discloses a mobile phone holder which can be opened or closed by a single push of one hand.

U.S. Pat. No. 6,594,505 B1, a Mobile Telephone System Capable of Coping with a Variety of Mobile Radio Telephone Systems by a Single Mobile Radio Telephone, describes a mobile telephone system capable of coping with a number of different mobile radio telephone systems by a single mobile radio telephone, allowing service in a wider range by processing means to demodulate and decode different communication protocol.

U.S. Pat. No. 6,882,871 B2, Transfer Connection Device for Wirelessly Connecting Mobile Phone and Hand-Free Handset, describes a transfer connection device for wirelessly connecting mobile phone and hand-free handset with first and second connectors to allow signal transmission between the two without a physical linking.

This U.S. patent describes a docking station for use with a Bluetooth-enabled cellular mobile handset, allowing mobility to the cellular mobile handset.

Yet, while the hands-free device of this patent is beneficial to the driver, it does not address the discomfort of the passenger.

Furthermore, there does not exist a wireless car-mounted wireless car-kit system for automobile use of a cellular phone with a full size easy to read caller identification display. The hands-free wireless car-kit devices of the prior art provide small caller identification displays, if any.

It is therefore an object of the present invention to provide a car-mounted wireless car-kit device providing a user with a full size corded handset, full size caller identification display, speaker phone capability and a designated key on the handset keypad activating a feature mode disabling keytones and allowing input and storage of alpha-numeric data even while the cellular phone is in use.

### BRIEF SUMMARY OF THE INVENTION

I have invented a Bluetooth-enabled transfer connection device for wirelessly connecting a cellular phone with a car-mounted car-kit comprising a junction box, a power source, a hang up cup to rest the device, a full size corded handset with a full size keypad and full size visual caller identification display, a connection element for connection to an external earpiece, and a wired connection to an external microphone and speaker system for speaker phone use, adapted for in-car use by a passenger or driver. In the preferred embodiment, the base portion will receive the handset in a substantially horizontal configuration, and the handset will be held in place with a locking clip. The preferred embodiment will further comprise a designated key on the keypad providing a novel notepad feature allowing alpha-numeric input and storing options while the telephone is in use and keytones are disabled. The designated key can be activated both when the telephone is in use or not in use. When the designated key, labeled PAD in the preferred embodiment, is depressed, the cellular phone will operate in the notepad mode, even while a call is in progress. In the notepad mode, the keytones will be disabled, and the car phone display will allow alpha-numeric input by pressing the keys on the keypad and storing of multiple separate notepad entries in the car phone's memory to be retrieved for later use.

### BRIEF DESCRIPTION OF THE SEVERAL VIEWS OF THE DRAWINGS

FIG. 1. is a back view of the handset portion of the car-mounted wireless car-kit system.

FIG. 2. is a side view of the handset portion of the car-mounted wireless car-kit system.

FIG. 3. is a front view of the handset portion of the car-mounted wireless car-kit system.

FIG. 4. is a side view of the car-mounted wireless car-kit system showing the connections between its various components.

FIG. 5. depicts the function of the designated PAD key.

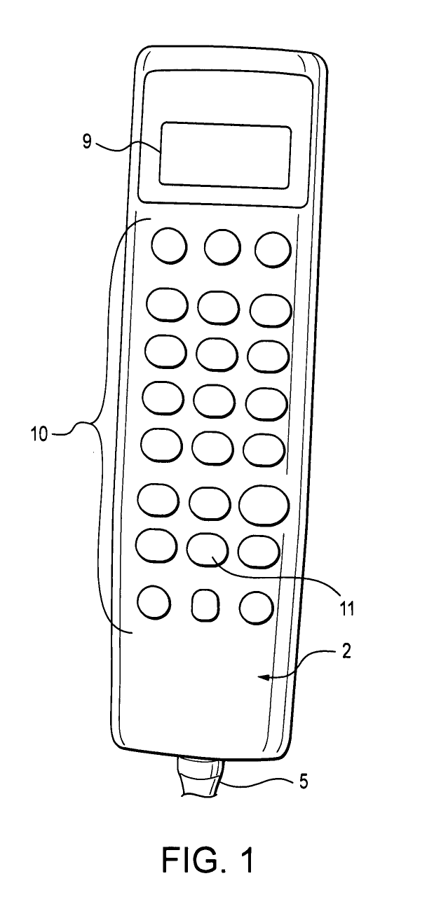

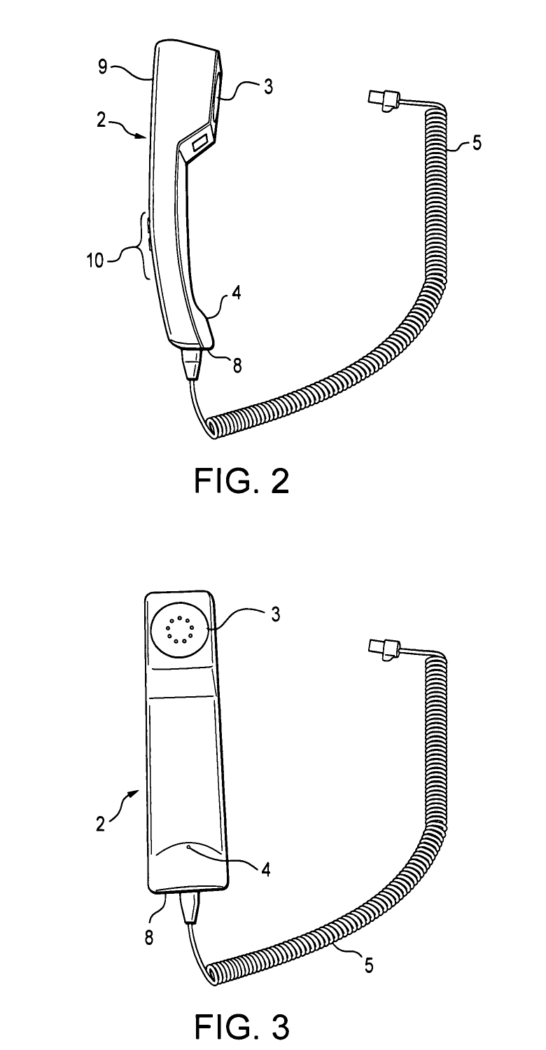

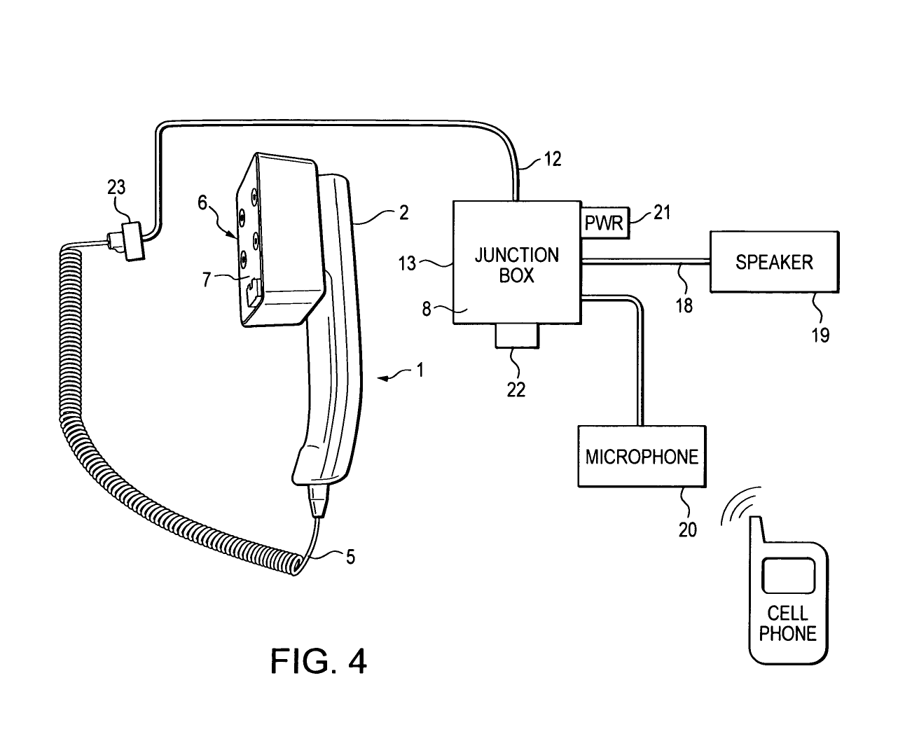

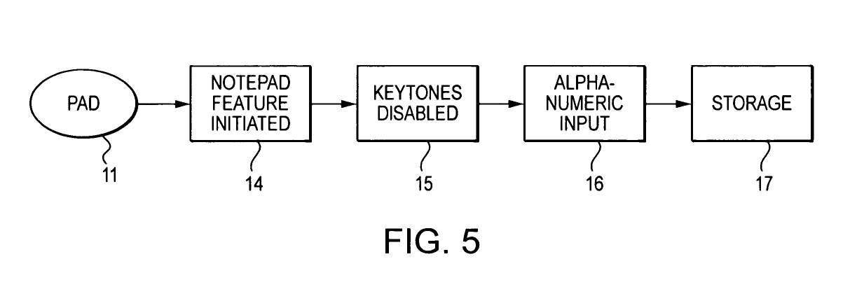

### DETAILED DESCRIPTION OF THE INVENTION

The car-mounted wireless car-kit 1, generally comprises an automobile mounted hang up cup 6, a full size corded handset 2 with a speaker 3, microphone 4, a wired 12 connection to a junction box 13, a power source 21, a wired 18 connection to an external speaker 19, a wired connection to an external microphone 20, a connection element 22 for connection to factory provided automobile speakers, a connection element 23 for connection to a standard 2.5 mm earpiece. The bottom 7 of the hang up cup 6 is permanently mounted to the interior of the automobile. The handset 2 is permanently connected to the junction box 13 with a telephone cord 5 and wire 12. The junction box 13 contains a transfer connection element 8, which will wirelessly connect to and communicate with the user's cellular phone, enabling communication over the cellular network via the car-mounted wireless car-kit system. The junction box 13 is an ordinary junction box further comprising the transfer connection element 8. The user can alternate between speaker phone mode or handset mode by lifting the handset 2 from the hang up cup 6. The speaker phone mode will operate either through the external speaker 19 or the car-mounted factory speakers through the connection 22. While in speaker phone mode, the user will talk into the external microphone 20. The external microphone 20 can be mounted anywhere in the automobile, preferably on the driver's sunvisor for ultimate ease of use by an automobile passenger or driver. The user will use the handset 2 as a control device while engaging in the speaker phone mode as well.

The car-mounted wireless car-kit system I further comprises a full size keypad 10 and full size visual display 9. In the preferred embodiment, the hang up cup 6 will receive the handset 2 in a substantially horizontal configuration, and the handset 2 will be held in place with a locking clip. In the preferred embodiment, the wireless technology is the Bluetooth protocol. The bottom 7 of the hang up cup 6 is permanently mounted to the interior of an automobile. In the preferred embodiment, the alpha-numeric visual display 9 is located on the back of the handset 2.

The car-mounted wireless car-kit system 1 further comprises a connection element 23 for connection to a standard 2.5 mm earpiece, allowing the user the option to communicate via an earpiece as well. While the user is engaged in a telephone call via the user's earpiece, a passenger can pick up the handset 2, and join the conversation, without activating the speaker phone mode. This feature operates like another extension of one telephone line in a telephone land line environment. This allows two individuals to have a conversation in an automobile environment without the need to activate the speaker phone mode. This provides many advantages to the user, including allowing a more private discussion without other passengers overhearing the party at the other end of the phone call, and allowing other passengers to speak to each other without the party on the other end of the phone call overhearing them as well.

When a user enters the automobile and activates the car-mounted wireless car-kit device, the transfer connection element for wirelessly connecting to a cellular phone 8 will wirelessly connect to and communicate with the user's cellular phone, using standard wireless connection technology, enabling communication over the cellular network via the car-mounted wireless car-kit system. The cellular phone can remain in the user's pocket or briefcase while the car-mounted wireless car-kit device is in use. The user will then utilize the full size handset as a control device while alternating between the handset mode or speaker-phone mode, without using the actual cellular phone at all.

The preferred embodiment further provides a designated PAD key 11 for alpha-numeric data storage during telephone use.

In the preferred embodiment, the PAD key 11 is a designated key on the keypad 10. When the PAD key 11 is depressed by the user, the PAD mode is activated 14, and the phone will operate in PAD mode. While in PAD mode, the auditory keytones are deactivated 15. Therefore, when a key on the keypad is pressed, no sound will be emitted. A user will then press the desired keys on the keypad resulting in the desired alpha-numeric input 16. The user will then be prompted for storage 17 of the alpha-numeric input. In the preferred embodiment, input and storage can be achieved both when the phone is in use and not in use. In the preferred embodiment, multiple entries will be stored separately for easy retrieval at a later time. In the preferred embodiment, storage for up to thirty separate entries will be provided, and the attempt to store a thirty first entry will erase the first stored entry.

In the preferred embodiment, the car-mounted wireless car-kit 1 will be connected to the automobile's existing speaker system through the connection element 22. However, the external speaker 19 can utilized as well, and will comprise a separate speaker mounted anywhere in the automobile, or on the handset or base portions of the instant invention.

The visual display 9 can be located anywhere on the car-mounted wireless car-kit 1. The car-mounted wireless car-kit device can provide multiple visual displays. A visual display can be provided on the hang up cup 6, or on either side of the handset 2.

We have illustrated a preferred embodiment of the invention. However, it is to be understood that changes and variations may be made by those skilled in the art without departing from the spirit of the invention as claimed.

Many variations of the invention will occur to those skilled in the art. All such variations are intended to be within the scope and spirit of the invention. Although some embodiments are shown to include certain features, I specifically contemplate that any feature disclosed in this description may be used together or in combination with any other feature on any embodiment of the invention. I have also contemplated that any feature may be specifically excluded from any embodiment of the invention.

Further aspects of the invention will become apparent from consideration of the drawings and the description of preferred embodiments of the invention. A person skilled in the art will realize that other embodiments of the invention are possible and that the details of the invention can be modified in a number of respects, all without departing from the inventive concept. Thus, the drawings and description are to be regarded as illustrative in nature and not restrictive.

### List of Reference Numbers:

1. Car-mounted wireless car-kit device
2. Full size corded telephone handset
3. Speaker
4. Microphone
5. Cord
6. Automobile mounted hang up cup
7. Bottom of hang up cup
8. Transfer connection element for wirelessly connecting to a cellular phone
9. Caller ID display
10. Keypad
11. PAD key
12. Wire
13. Junction box
14. Notepad Feature Initiated
15. Keytones Disabled
16. Alpha-Numeric Input
17. Storage
18. Wire
19. Speaker
20. Microphone
21. Power
22. Connection to factory car speaker
23. Connection for earpiece

1. A car-mounted wireless car-kit device comprising:
a. A full size corded telephone handset with a speaker and microphone;
b. An automobile mounted base portion adapted to receive said full size corded telephone handset;
c. A junction box containing a transfer connection element enabling wireless connection to a portable cellular phone and a power source;
d. A wire cord permanently connecting said full size corded handset to said junction box;

2. The car-mounted wireless car-kit device of claim 1 in which said transfer connection element enabling wireless connection to a portable cellular phone further comprises the Bluetooth protocol technology.

3. The car-mounted wireless car-kit device of claim 1 further comprising a wired connection to an external speaker and a wired connection to an external microphone.

4. The car-mounted wireless car-kit device of claim 1 further comprising a wired connection to a pre-existing automobile speaker system.

5. The car-mounted wireless car-kit device of claim 1 in which said base portion will receive said full size corded telephone handset in a substantially horizontal configuration.

6. The car-mounted wireless car-kit device of claim 1 further comprising a connection to a standard 2.5 mm earpiece device.

7. The car-mounted wireless car-kit device of claim 1 further comprising at least one visual display.

8. The car-mounted wireless car-kit device of claim 1 further comprising at least one alpha-numeric caller identification display.

9. The car-mounted wireless car-kit device of claim 1 further comprising at least one visual display on said full size corded telephone handset.

10. The car-mounted wireless car-kit device of claim 1 further comprising at least one visual display on said base portion.

11. The car-mounted wireless car-kit device of claim 1 further comprising a means to secure said handset to said base when not in use.

12. The car-mounted wireless car-kit device of claim 1 further comprising a means to secure said handset to said base when not in use, said means comprising a locking clip.

13. The car-mounted wireless car-kit device of claim 1 further comprising a keypad.

14. The car-mounted wireless car-kit device of claim 1 further comprising a designated key enabling input and storage of alpha-numeric data without activating keytones.

15. A car-mounted wireless car-kit device comprising:
a. A full size corded telephone handset with a speaker, microphone, and keypad;
b. An automobile mounted base portion adapted to receive said full size corded telephone handset;
c. A junction box containing a transfer connection element enabling wireless connection a portable cellular phone;
d. A wire cord permanently connecting said full size corded handset to said junction box;
e. A designated key enabling input and storage of alpha-numeric data without activating keytones.

16. The car-mounted wireless car-kit device of claim 13 in which said designated key is located on said keypad of said handset.

17. The car-mounted wireless car-kit device of claim 13 in which said designated key further enables input and storage of at least one unique set of alpha-numeric data.

18. The car-mounted wireless car-kit device of claim 13 in which said designated key further enables input and storage of at least two unique sets of alpha-numeric data.

19. A method for using a cellular phone in an automobile environment, the method comprising the steps of: providing a full size corded telephone handset with a speaker, microphone, and keypad, an automobile mounted base portion adapted to receive said full size corded telephone handset, a junction box comprising a transfer connection element enabling wireless connection a portable cellular phone and a power source, and a wire cord permanently connecting said full size corded handset to said junction box.

20. The method of claim 19 further comprising the steps of: providing a designated key on the keypad, activating a notepad feature mode by depressing said designated key while connected to a cellular phone network, said notepad feature mode deactivating keytones and allowing input and storage of multiple alpha-numeric notepad entries for later access and retrieval.
